(19) United States
(12) Patent Application Publication
(10) Pub. No.: US 2008/0293592 A1
(43) Pub. Date: Nov. 27, 2008

(54) Method For Covalently Immobilising Biomolecules on Organic Surfaces

(76) Inventors: Jurgen Ruhe, Eichstatten (DE); Holger Klapproth, Freiberg (DE)

Correspondence Address: THE WEBB LAW FIRM, P.C., 700 KOPPERS BUILDING, 436 SEVENTH AVENUE, PITTSBURGH, PA, 15219, US

(21) Appl. No.: 10/591,064

(22) PCT Filed: Mar. 1, 2005
(86) PCT No.: PCT/EP2005/002137

§ 371 Date: Aug. 13, 2008

(30) Foreign Application Priority Data
Mar. 1, 2004 (DE) 10 2004 010 430.1

(51) Int. Cl. C40B 40/04; C40B 50/18

(52) U.S. Cl. 506/15; 506/32

(57) ABSTRACT

The invention relates to a method for covalently immobilising probe-biomolecules on organic surfaces by means of photoreactive cross-linking agents which are used for covalently immobilising the probe-biomolecules on an organic surface. The inventive immobilising method consists in applying said probe-biomolecules and photoactive polymers and afterwards in cross-linking.

The invention relates to a method for covalently immobilizing probe-biomolecules on organic surfaces such as polymer surfaces, or surfaces of inorganic substrates modified with self-assembled monolayers, by means of photoreactive cross-linking agents, which are used to covalently immobilize the probe-biomolecules on an organic surface. Polymers or copolymers with photoreactive groups are used as cross-linking agents, which bond to the probe-molecule and also ensure the covalent bonding to the surface after they have been applied.

In recent years, such techniques have become increasingly more important in analysis and there are numerous solid phase systems that have been developed on the basis of self-assembled monolayers (SAMs) of bifunctional molecules (linkers), by which specific probe-molecules are bonded or conjugated to the surface of the solid substrate, on which they can then be detected with the aid of suitable markers (for example, radioactive, dye, fluorescent).

In a manner analogous to the designation microchips in electronics, the designation “sensor chips” has come into use for these systems. The term “biochips” is also used for the conjugation of biological molecules (so-called “bioconjugation”) such as oligonucleotides or antibodies on such sensor chips. The bonding to the carrier surface may be either direct or indirect. An example of indirect bonding is the bonding of a nucleic acid sequence to be detected by the hybridization of said sequence to an immobilized, complementary oligonucleotide probe. In this case, the use of the probe has the additional advantage of the natural specificity of the interaction of biological macromolecules.

Typically in the production of sensor chips, surfaces made from metal or semi-metal oxides, for example aluminum oxide, quartz glass, glass, are immersed in a solution of bifunctional molecules (so-called “linkers”), which for example have a halogen silicate (e.g. silicon chloride) or alkoxyl silicate group to bond to the carrier surface in such a way that a self-assembled monolayer (SAM) forms. In this case, said layer is only a few angstroms thick. The linker is bonded to the probe or probe molecule by means of an additional suitable functional group, for example an amino or an epoxy group (EP 1 176 422 A1). Suitable bifunctional linkers for bonding numerous probe- or tracer molecules, especially those of biological origin, to numerous carrier surfaces are well-known to the person skilled in the art; see for example “Bioconjugate Techniques” by G. T. Hermanson, Academic Press 1996.

A disadvantage of these reactive (and therefore sensitive) surfaces, e.g., surfaces with epoxy, aldehyde or amino functions, is their often limited stability in storage (a few weeks), which requires them to be stored hermetically sealed and/or in darkness. Furthermore, the resultant bonds to the biomolecules or to the surface lack long-term stability. All of these bonds are subject to effects such as hydrolysis, which severely restrict the utility and the spectrum of use. In particular, the existing methods do not allow printing on hydrophilic surfaces or surfaces with a hydrophilic coating without the risk of the drops being displaced and thereby destroying the printing result.

The immobilization of, for example, nucleic acids on non-reactive polymer or synthetic/plastic surfaces (e.g., as probes for the production of sensor/biochips) with traditional methods is, however, complicated and requires considerable effort.

The objective of the invention is therefore the preparation of an easy and expedient method for covalently immobilizing probe-biomolecules on organic surfaces such as polymer surfaces or inorganic substrates modified with organic substances. Another objective of the invention is the achievement of a considerably higher bonding capacity on carrier substrates in comparison with that of the prior art. Previous approaches such as, e.g., EP 1 144 677 A2, were not able to provide a satisfactory solution to this problem. Another objective of this invention is the preparation of a stable bonding chemistry and an improved printability of hydrophilic and hydrophobic surfaces.

This objective is solved according to the invention by the following technical teaching:
a) at least one probe-biomolecule with at least one polymer and/or copolymer, which has at least two photoreactive groups per molecule, is dissolved and
b) the mixture from (a) is applied to a surface and covalently immobilized thereon by irradiation with light of a suitable wavelength.

In a preferred embodiment, the polymer comprises a plurality of photocross-linkable groups so that in the cross-linking the biomolecules are covalently bonded to the polymer, the polymer molecules are covalently bonded to the substrate, and the polymer chains are cross-linked among each other.

The advantage of the invention lies in the possibility of printing a viscous medium on inert surfaces (e.g., silicated glass carriers or substrates made from commercially available synthetic materials), wherein said medium is very easy to immobilize, namely by irradiation with light of a suitable wavelength. At the same time, this process considerably increases the quantity of analyte that can be bonded, as a pseudo-three dimensional matrix is formed. In addition, the classic problems with three-dimensional matrices, such as the displacement effects of the medium during printing on polymer gels, are solved in this manner. Furthermore, printing on reactive (and therefore sensitive) surfaces is not possible. Surfaces with epoxy, aldehyde, or amino functions are examples of reactive surfaces. Reactive surfaces often have limited stability (a few weeks) and must be stored hermetically sealed. No reactive surface means that carriers of, for example, polystyrene or polymethylmethacrylate (PMMA), which remain stable for years, may be used. Another advantage is that, for example, the polymer surfaces do not have to be hydrophilized by preliminary processing steps such as plasma processing, because the surface in the alternative embodiment of the method of the invention defined above, for example, is made accessible by means of the bonded (swellable, wettable) copolymer. Apart from this, the surface properties of the substrate (for example the sensor surface) may also be checked readily and very accurately. An example of an important surface property that can readily be checked with the aid of the method described herein is wettability. Another advantage is the simplified analysis, as in principle only the volume of the applied drop must be determined and the number of immobilized probes is then derived directly therefrom. With the prior art method for the bonding of, for example, DNA to SAMs, this is not a trivial undertaking.

The invention further relates to an organic surface such as a polymer surface with probe-biomolecules covalently immobilized thereon, preferably forming a pattern (e.g., by printing on it), which surface can be obtained according to a method defined above.

The invention further relates to the use of an organic surface, such as a polymer surface with probe-biomolecules immobilized thereon and forming a pattern, as a sensor chip; furthermore, according to an additional embodiment it relates to a medical or diagnostic instrument that has an organic surface of the invention, such as a polymer surface, or a sensor chip obtained therewith.

Advantageous and/or preferred embodiments of the invention are objects of the subordinate claims.

In a preferred method, the photoreactive group(s) can be chosen from benzophenone or its derivatives, anthraquinone or its derivatives, nitrophenylazide and derivatives, and thymidine or its derivatives. Other suitable photocrosslinkers are known to the prior art and can be obtained, for example, from companies such as Pierce (www.piercenet.com). In general, however, all chemical groups that are capable of forming radicals or other reactive groups under irradiation may be used.

For the method of the invention, polymer surfaces, such as surfaces made of cycloolefin copolymers (COCs), polystyrene, polyethylene, polypropylene or polymethylmethacrylate (PMMA, Plexiglas) are examples of suitable organic surfaces. Ticona markets an example of a suitable COC under the trade name “Topas.” It must be expressly mentioned here that the method of the invention in relation to the photoreactive groups used is suitable for any organic surface. For example, surfaces coated with organic molecules such as inorganic substrates coated with self-assembled monolayers (SAMs) are also suitable for this purpose. These SAMs themselves may be completely inert and thus may consist, for example, purely of alkylsilicates. In addition to organic substrates, other substrates are also suitable, as long as these substrates are able to form stable bonds (e.g., organoboron compounds) with organic molecules by radical processes.

In the method of the invention, the probe-biomolecule may be a partner, for example, of a specifically interacting system of complementary bonding partners (receptor/ligand).

Examples of receptors include, but are not limited to: nucleic acids and their derivatives (RNA, DNA, LNA, PNA), proteins, peptides, polypeptides and their derivatives (glucosamine, antibodies, enzymes), and also fatty acids such as arachidonic acid and other compounds, to the extent that said compounds can undergo specific interactions with at least a second molecule. Additional receptors include larger and composite structures such as liposomes, membranes and membrane fragments, cells, cell lysates, cell fragments, spores, and microorganisms.

Examples of ligands include, but are not limited to: nucleic acids and their derivatives (RNA, DNA, LNA, PNA), proteins, peptides, polypeptides and their derivatives (glucosamine, antibodies, enzymes), and also fatty acids such as arachidonic acid and other compounds, to the extent that said compounds can undergo specific interactions with at least one other molecule. Additional receptors include larger and composite structures such as liposomes, membranes and membrane fragments, cells, cell lysates, cell fragments, spores, and microorganisms.

A specifically interacting system of complementary bonding partners can be based on, for example, the interaction of a nucleic acid with a complementary nucleic acid, the interaction of a peptide nucleic acid (PNA) with a nucleic acid, or the enzyme/substrate, receptor/ligand, lectin/sugar, antibody/antigen, avidin/biotin or streptavidin/biotin interaction.

Obviously the nucleic acid can be a DNA or an RNA, for example an oligonucleotide or an aptamer or even a so-called “LNA,” such as that available at www.proligo.com, or also a DNA that can be imbedded into a polymer such as that available at www.mosaic-technologies.com under the trade name of “Acrydite.” Peptide nucleic acids (PNAs) are another option.

The antibody may be, for example, a polyclonal, monoclonal, chimeric, or “single chain” antibody or a functional fragment or derivative of such an antibody (“functional” means that the fragment/derivative can bond to an antigen without necessarily producing an immunogenic response).

In the following, the invention will be explained in more detail with reference to, but not limited to, concrete embodiments and examples wherein nucleic acids are used as probe-biomolecules. Shown is:

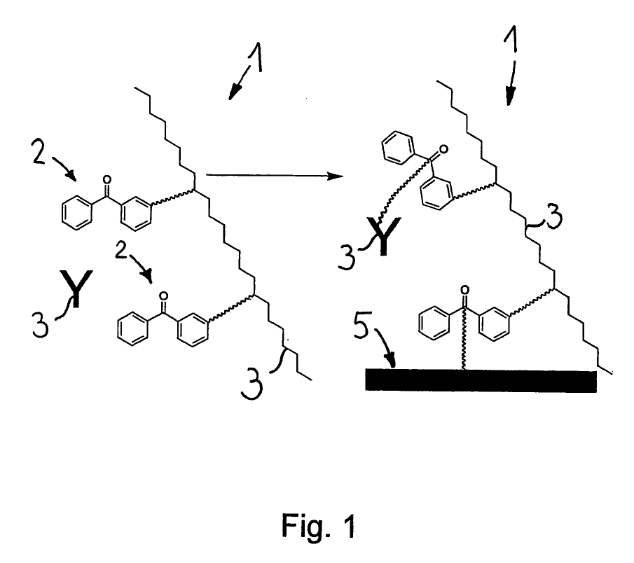

FIG. 1 a schematic illustration of the cross-linking of biomolecules and a copolymer.

### MANUFACTURE OF THE COPOLYMER

A copolymer designated by 1 in FIG. 1 can be formed from a monomer 3 comprising a UV reactive group 2, a reactive hydrophilic monomer. Example: 4-methacryloyloxybenzophenone, dimethylacrylamide, and methacrylic acid.

For example, a suitable copolymer can be produced by means of the copolymerization of dimethylacrylamide and 4-methacryloyloxybenzophenone in a 100:1 (mol/mol) mixture by the addition of 1% AIBN (azobisisobutyronitrile) to a solution of monomers in a suitable solvent (e.g., 10% (v/v) monomers in chloroform). The resulting copolymer can then be precipitated out with diethyl ether.

The copolymer 1, for example, can be swollen in a suitable solvent and mixed, for example, with a 5′ oligothymine-modified nucleic acid such as DNA.

The mixture of the biomolecule 4 and the copolymer 1 thus obtained, which is shown at the left in FIG. 1, can now be analyzed (to determine the DNA content) and applied to nearly any organic polymer surface 5 serving as a substrate by printing (FIG. 1, right). The immobilization of the polymer and the cross-linking with the biomolecule 4 is achieved, for example, by means of UV irradiation at a wavelength of 260 nm.

This polymer can then be printed onto a PMMA substrate by means of a method known to the person skilled in the art. The immobilization of the modified polymers is achieved herein on the one hand by a photoinduced cross-linking reaction between the benzophenone groups contained in the polymer and the substrate, activated by UV irradiation at 260 nm, and on the other hand by a photoinduced cross-linking reaction between the oligothymine and the polymer, and/or the photoinduced cross-linking reaction between the benzophenone and the nucleic acid.

1. A method for covalently immobilizing probe-biomolecules on organic surfaces, wherein
(a) at least one probe-biomolecule with at least one polymer and/or copolymer, which has at least two photoreactive groups per molecule, is dissolved and
(b) the mixture from (a) is applied to a surface and covalently immobilized thereon by irradiation with light of a suitable wavelength.

2. A method as in claim 1, wherein the polymer is a swellable polymer, in which there are at least two identical or different photocross-linkable groups per polymer chain and/or the copolymer is a swellable copolymer, in which there are at least two identical or different photocross-linkable groups per copolymer chain.

3. A method as in claim 1, wherein the polymer and/or copolymer is/are applied to the surface by printing and then cross-linked afterwards.

4. A method as in claim 1, wherein benzophenone or its derivatives, anthraquinone or its derivatives, nitrophenylazide and thymidine or their derivatives is/are used as (a) photoreactive group(s).

5. A method as in claim 1, wherein the photoreactive group(s) is/are ultraviolet-reactive.

6. A method as in claim 1, wherein the application in step (b) defined in claim 1 results in the formation of a pattern through printing.

7. A method as in claim 1, wherein the polymer surface consists of cycloolefin copolymers, polystyrene, polyethylene, polypropylene, or polymethylmethacrylate.

8. A method as in claim 1, wherein a partner of a specifically interacting system of complementary bonding partners (receptor/ligand) is used as a probe-biomolecule.

9. A method as in claim 8, wherein the specifically interacting system of complementary bonding partners is based on the interaction of a nucleic acid with a complementary nucleic acid, the interaction of a peptide nucleic acid (PNA) with a nucleic acid, or the enzyme/substrate, receptor/ligand, lectin/sugar, antibody/antigen, avidin/biotin or streptavidin/biotin interaction.

10. A method as in claim 9, wherein the nucleic acid is a DNA or an RNA or an analog thereof.

11. A method as in claim 10, wherein the DNA or RNA is an oligonucleotide.

12. A method as in claim 11, wherein the antibody is a polyclonal, monoclonal, chimeric, or “single chain” antibody or a functional fragment or a derivative of such an antibody.

13. An organic surface with probe-biomolecules covalently immobilized thereon, attainable by a method as in claim 1.

14. An organic surface with probe-biomolecules covalently immobilized thereon, wherein a pattern is formed, attainable by a method as in claim 1.

15. A sensor chip comprising an organic surface as in claim 13.

16. A medical or diagnostic instrument comprising an organic surface as in claim 13.
